(19) United States
(12) Patent Application Publication
(10) Pub. No.: US 2025/0299571 A1
(43) Pub. Date: Sep. 25, 2025

(54) SYSTEMS AND METHODS OF MANAGING DATA RELAY ATTACKS

(71) Applicant: Ford Global Technologies, LLC, Dearborn, MI (US)

(72) Inventors: Krishna Bandi, Novi, MI (US); Somak Datta Gupta, Novi, MI (US); Gregory P. Linkowski, Dearborn, MI (US); Meghna Menon, Ann Arbor, MI (US); Mario Anthony Santillo, Canton, MI (US)

(73) Assignee: Ford Global Technologies, LLC, Dearborn, MI (US)

(21) Appl. No.: 18/612,753

(22) Filed: Mar. 21, 2024

(51) Int. Cl. G08G 1/09; G08G 1/01; H04W 12/122; H04W 64/00

(52) U.S. Cl. CPC G08G 1/093; G08G 1/0116; G08G 1/0141; H04W 12/122; H04W 64/006

(57) ABSTRACT

A method including the causation of a first road-side unit to broadcast one or more messages to one or more vehicles, the determination by an infrastructure-side algorithm of whether one or more messages received by a second road-side unit matches the one or more messages broadcasted by the first road-side unit, and the causation of the one or more vehicles to initiate one or more remedial actions in response to determining that the one or more messages received by the second road-side unit do not match the one or more messages broadcasted by the first road-side unit within a predefined timeframe.

### FIELD

The present disclosure relates to the identification, detection, and communication of a data relay attack.

### BACKGROUND

The statements in this section merely provide background information related to the present disclosure and may not constitute prior art.

Relay attacks, or replay attacks, are a variant of man-in-the-middle attacks that result in the repetition or delay of valid data transmission between one or more devices. In a vehicular network setting, replay attacks often target communications between an on-board unit of a vehicle and a road-side unit. When such a replay attack occurs, the originating device associated with the replay attack will be able to authenticate itself at a later time with the road-side unit or the vehicle being unaware of that later authentication. Additionally, it is difficult for any vehicle or any road-side unit to mitigate the effects of a replay attack because the vehicle or road-side unit is unable to recognize that it is under attack.

The present disclosure addresses these and other issues related to the identification, detection, and communication of a replay attack.

### SUMMARY

This section provides a general summary of the disclosure and is not a comprehensive disclosure of its full scope or all of its features.

The present disclosure provides a method comprising: causing, by an infrastructure controller, a first road-side unit to broadcast one or more messages to one or more vehicles; determining, by an algorithm associated with the infrastructure controller, whether one or more messages received by a second road-side unit matches the one or more messages broadcasted by the first road-side unit; and causing, by the infrastructure controller, the one or more vehicles to initiate one or more remedial actions in response to determining that the one or more messages received by the second road-side unit do not match the one or more messages broadcasted by the first road-side unit within a predefined timeframe; further comprising: causing, by the infrastructure controller, the second road-side unit to validate the one or more messages, wherein the second road-side unit is configured to receive the one or more messages based on a location of the first road-side unit, and wherein the validation of the one or more messages is based on the one or more messages matching one or more sanitized operating scenarios defined by a channel busy ratio; wherein the one or more remedial actions include: triggering a global pause in operation of all of the one or more vehicles; triggering a zonal pause in operation of a subset of the one or more vehicles; identifying one or more targeted vehicles of the one or more vehicles; or triangulating, via one or more received signal strength indicator triangulation methods, a location of a third party, wherein the third party is a road-side unit, an on-board unit associated with a vehicle, or a mobile device; further comprising: causing, by the algorithm, one or more instructions to be transmitted to one or more road-side units, wherein the one or more road-side units include at least the first road-side unit and the second road-side unit; and further comprising: causing the one or more road-side units to randomly change a data rate associated with each of the one or more road-side units based on the one or more instructions; causing the one or more road-side units to isolate and identify replayed data associated with the one or more messages broadcasted by the first road-side unit based on the one or more instructions; or causing the one or more road-side units to isolate and identify a location of a third party, wherein the identification of the location of the third party is based on a signal strength of the one or more road-side units, and wherein the third party is a road-side unit, an on-board unit associated with a vehicle, or a mobile device.

The present disclosure provides another method comprising: predicting, via a probabilistic analysis, that data associated with one or more messages broadcasted by one or more road-side units is compromised, wherein the prediction is enabled by an algorithm associated with a vehicle controller; and initiating, by the vehicle controller, one or more remedial actions in response to predicting that the data associated with the one or more messages broadcasted by the one or more road-side units is compromised; further comprising: determining, by the vehicle controller, whether one or more messages broadcasted from the vehicle match a broadcast history associated with the vehicle; further comprising: initiating, by the vehicle controller, the one or more remedial actions in response to determining that the one or more messages broadcasted from the vehicle does not match the broadcast history; wherein the one or more remedial actions include: triggering a pause in operation of the vehicle; transmitting an alert to a central server, a vehicle manufacturing cloud system, one or more operators, or a combination thereof; or adjusting one or more outgoing data patterns associated with one or more messages broadcasted from the vehicle, wherein the one or more outgoing data patterns include a data rate, a ProSe per packet priority, a modulation and coding scheme, a packet size, or a combination thereof; wherein the one or more outgoing data patterns are cross-referenced against the one or more messages broadcasted from the vehicle; and further comprising: identifying one or more messages broadcasted by one or more adjacent vehicles, wherein the one or more messages broadcasted by the one or more adjacent vehicles include an alteration of a data rate, a jump in a signal strength, or a combination thereof; and transmitting an alert to a central server based on the identification of the one or more messages broadcasted by the one or more adjacent vehicles.

The present disclosure provides a system comprising: an infrastructure controller configured to: cause a first road-side unit to broadcast one or more messages to one or more vehicles, determine, by an algorithm associated with the infrastructure controller, whether one or more messages received by a second road-side unit matches the one or more messages broadcasted by the first road-side unit, and cause the one or more vehicles to initiate a first set of remedial actions in response to determining that the one or more messages received by the second road-side unit do not match the one or more messages broadcasted by the first road-side unit within a predefined timeframe; and a vehicle controller configured to: predict, via a probabilistic analysis, that data associated with one or more messages broadcasted by one or more road-side units is compromised, wherein the prediction is enabled by an algorithm associated with the vehicle controller, and initiate a second set of remedial actions in response to predicting that the data associated with the one or more messages broadcasted by the one or more road-side units is compromised; wherein the infrastructure controller is further configured to: cause the second road-side unit to validate the one or more messages, wherein the second road-side unit is configured to receive the one or more messages based on a location of the first road-side unit, and wherein the validation of the one or more messages is based on the one or more messages matching one or more sanitized operating scenarios defined by a channel busy ratio; wherein the first set of remedial actions include: triggering a global pause in operation of all of the one or more vehicles; triggering a zonal pause in operation of a subset of the one or more vehicles; identifying one or more targeted vehicles of the one or more vehicles; or triangulating, via one or more received signal strength indicator triangulation methods, a location of a third party, wherein the third party is a road-side unit, an on-board unit associated with a vehicle, or a mobile device; wherein the infrastructure controller is further configured to: cause, by the algorithm associated with the infrastructure controller, one or more instructions to be transmitted to one or more road-side units, wherein the one or more road-side units include at least the first road-side unit and the second road-side unit; wherein the infrastructure controller is further configured to: cause the one or more road-side units to randomly change a data rate associated with each of the one or more road-side units based on the one or more instructions; cause the one or more road-side units to isolate and identify replayed data associated with the one or more messages broadcasted by the first road-side unit based on the one or more instructions; or cause the one or more road-side units to isolate and identify a location of a third party, wherein the identification of the location of the third party is based on a signal strength of the one or more road-side units, and wherein the third party is a road-side unit, an on-board unit associated with a vehicle, or a mobile device; wherein the vehicle controller is further configured to: determine whether one or more messages broadcasted from the vehicle match a broadcast history associated with the vehicle; and initiate the one or more remedial actions in response to determining that the one or more messages broadcasted from the vehicle does not match the broadcast history; wherein the second set of remedial actions include: triggering a pause in operation of the vehicle; transmitting an alert to a central server, a vehicle manufacturing cloud system, one or more operators, or a combination thereof; or adjusting one or more outgoing data patterns associated with one or more messages broadcasted from the vehicle, wherein the one or more outgoing data patterns include a data rate, a ProSe per packet priority, a modulation and coding scheme, a packet size, or a combination thereof; wherein the one or more outgoing data patterns are cross-referenced against the one or more messages broadcasted from the vehicle; and wherein the vehicle controller is configured to: identify one or more messages broadcasted by one or more adjacent vehicles, wherein the one or more messages broadcasted by the one or more adjacent vehicles include an alteration of a data rate, a jump in a signal strength, or a combination thereof; and transmit an alert to a central server based on the identification of the one or more messages broadcasted by the one or more adjacent vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an overall system for vehicle marshaling in accordance with various implementations;

FIGS. 2A and 2B illustrate an example system for marshaling one or more vehicles with a third party present in accordance with various implementations;

FIG. 3 illustrates a process flow associated with an algorithm for detecting the third party shown in FIG. 2 in accordance with various implementations;

FIG. 4 is a flowchart illustrating an example method for detecting the third party shown in FIG. 2 in accordance with various implementations; and

FIG. 5 is a flowchart illustrating another example method for detecting a third party shown in FIG. 2 in accordance with various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides for an identification of data replay attacks (e.g., data relay attacks) in an instance where one or more autonomous vehicles are being marshaled. For example, the disclosed systems and methods provide one or more processes to enhance one or more responses to replay attacks transmitted from one or more malicious devices. As another example, once a replay attack is detected, the originating device can be isolated and/or identified based at least on a received signal strength indicator (RSSI). As yet another example, implementable mitigation measures when replay attacks are detected are further provided by the disclosed systems and methods. As a further example, the disclosed systems and methods allow for the differentiation between unintentionally misconfigured devices and intentionally malicious devices using device activity history as a basis for such a differentiation. For example, the disclosed systems and methods also prevent interruptions in operation processes, such as manufacturing lines, which prevents unnecessary stoppages in the manufacturing process. Additionally, one or more disclosed systems and methods enhance the robustness of marshaling by mitigating any potential malicious replay attacks in a timely manner.

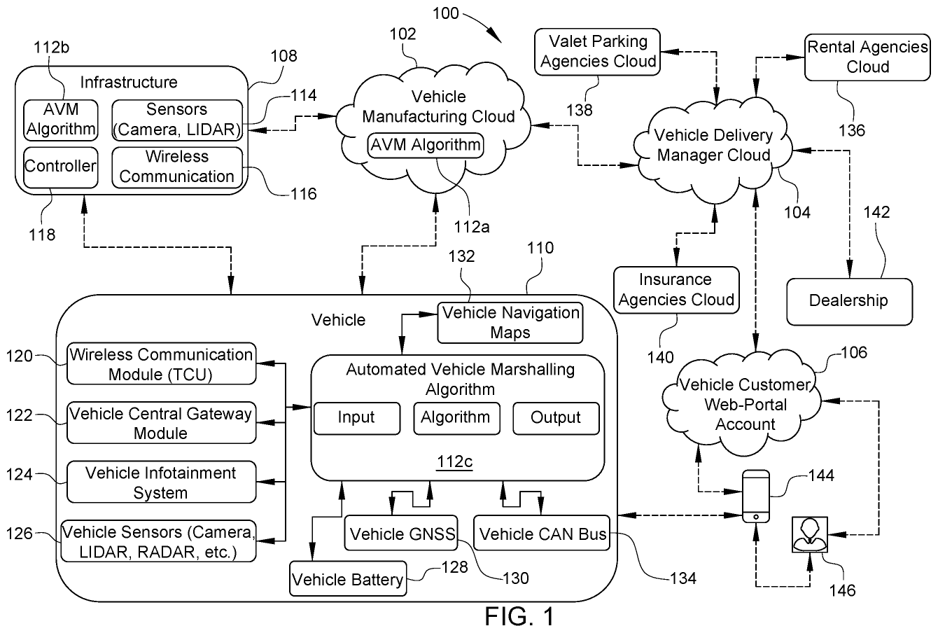

FIG. 1 shows a schematic block diagram illustration of an autonomous vehicle marshaling (AVM) system 100. The AVM system 100, in one or more examples, marshals one or more autonomous vehicles traveling at a low speed. However, it is understood that the AVM system 100 may marshal one or more vehicles traveling at any speed. It is also understood that the AVM system 100 may marshal semi-autonomous vehicles and/or fully autonomous vehicles.

The AVM system 100 generally includes a vehicle manufacturing cloud system 102, a vehicle delivery manager cloud system 104, a vehicle customer web-portal account cloud system 106, an infrastructure system 108, and an autonomous vehicle 110 of the one or more autonomous vehicles. The vehicle manufacturing cloud system 102 operates as the central cloud system that manages and/or facilitates any manufacturing process associated with the autonomous vehicle 110. The vehicle manufacturing cloud system 102 wirelessly communicates with the vehicle delivery manager cloud system 104 and the infrastructure system 108. The vehicle manufacturing cloud system 102 also wirelessly communicates with the autonomous vehicle 110 directly. One or more examples provide enhanced detection of a malicious actor device within the marshaling setting with one or more of the systems. For example, the malicious actor device is a third party that can be, but is not limited to, a road-side unit, an on-board unit associated with a vehicle, or a mobile device.

The vehicle manufacturing cloud system 102 includes an AVM algorithm 112a. The AVM algorithm 112a processes status information associated with at least the autonomous vehicle 110. It is understood that the AVM algorithm 112a processes status information associated with each autonomous vehicle of the one or more autonomous vehicles (e.g., the autonomous vehicle 110). The vehicle manufacturing cloud system 102 is configured to cause the infrastructure system 108 to monitor the progression of each of the one or more autonomous vehicles as the one or more autonomous vehicle(s) progress through an environment (e.g., a manufacturing facility or a parking lot). The vehicle manufacturing cloud system 102 is also configured to cause the infrastructure system 108 to communicate with any of the one or more autonomous vehicles. For example, the vehicle manufacturing cloud system 102 utilizes the AVM algorithm 112a to send instructions to the infrastructure system 108 and/or to process information received from the infrastructure system 108. The vehicle manufacturing cloud system 102 is configured to cause the vehicle delivery manager cloud system 104 to facilitate a delivery of the one or more autonomous vehicles to various locations. For example, the vehicle manufacturing cloud system 102 utilizes the AVM algorithm 112a to send instructions to the vehicle delivery manager cloud system 104 and/or to process information received from the vehicle delivery manager cloud system 104.

The vehicle manufacturing cloud system 102 is also configured to cause the one or more autonomous vehicles to start, stop, or pause progression through the environment, for example. The vehicle manufacturing cloud system 102 is further configured to control a marshaling speed of each of the one or more autonomous vehicles as the one or more autonomous vehicles traverse the environment, for example. In some examples, the vehicle manufacturing cloud system 102 utilizes the AVM algorithm 112a to send instructions to the autonomous vehicle 110 and/or to process information received from the autonomous vehicle 110.

The infrastructure system 108 includes an AVM algorithm 112b, one or more sensors 114, and a sensor component 116. The sensor component 116 provides for communication between one or more infrastructure systems and the one or more autonomous vehicles. For example, the sensor component 116 may utilize GPS, Wi-Fi, satellite, 3G/4G/5G, and/or Bluetooth™ to communicate with the one or more autonomous vehicles. The sensor component 116 also communicates with the one or more sensors 114, such as, for example, one or more of cameras, lidar, radar, and/or ultrasonic devices. The one or more sensors 114 monitor the movement of each of the one or more autonomous vehicles as the autonomous vehicle(s) traverse the environment. As an example, the infrastructure system 108 utilizes the AVM algorithm 112b to process and send information to the vehicle manufacturing cloud system 102 and/or to process information received from the vehicle manufacturing cloud system 102. As another example, the infrastructure system 108 utilizes the AVM algorithm 112b to process and send information directly to the autonomous vehicle 110 and/or to process information received from the autonomous vehicle 110. It is understood that the infrastructure system 108 can forward instructions received from the vehicle manufacturing cloud system 102 to the autonomous vehicle 110. However, it is also understood that the infrastructure system 108 can send instructions to the autonomous vehicle 110 directly.

Additionally, the infrastructure system 108 includes an infrastructure controller 118. The infrastructure controller 118 is configured to centrally control the operation of the autonomous vehicle 110. For example, the operation of the autonomous vehicle 110 includes propulsion, braking, and steering of the autonomous vehicle 110. It is understood that the infrastructure controller 118 may be disposed within the infrastructure system 108 or externally located relative to the infrastructure system 108. For example, in a marshaling environment (e.g., a manufacturing environment 200), the infrastructure system 108 wirelessly broadcasts a marshaling infrastructure-message to the autonomous vehicle 110. As another example, the marshaling infrastructure-message is broadcast over a vehicle-to-everything (V2X) protocol. However, it is understood that any communication means, including any communication protocol, may be used to broadcast the marshaling infrastructure-message.

The autonomous vehicle 110 includes one or more systems or components that implement or use an AVM algorithm 112c, a wireless transmission module 120, a vehicle central gateway module 122, a vehicle infotainment system 124, one or more vehicle sensors 126, a vehicle battery 128, a vehicle global navigation satellite system (GNSS) 130, vehicle navigation maps 132, and a vehicle CAN bus 134. The wireless transmission module 120 may be a transmission control unit. The wireless transmission module 120 includes one or more sensors that are configured to gather data and send signals to other components of the autonomous vehicle 110. The one or more sensors of the wireless transmission module 120 may include a vehicle speed sensor (not shown) configured to determine a current speed of the autonomous vehicle 110; a wheel speed sensor (not shown) configured to determine if the autonomous vehicle 110 is traveling at an incline or a decline; a throttle position sensor (not shown) determines if a downshift or upshift of one or more gears associated with the autonomous vehicle 110 is required in a current status of the autonomous vehicle 110; and/or a turbine speed sensor (not shown) configured to send data associated with a rotational speed of a torque converter of the autonomous vehicle 110. The wireless transmission module 120 communicates information, obtained by the one or more sensors, to the AVM algorithm 112c. For example, the autonomous vehicle 110 utilizes the AVM algorithm 112c to process and send information gathered by the one or more sensors to the infrastructure system 108. As another example, the autonomous vehicle 110 utilizes the AVM algorithm 112c to process and send information obtained by the one or more sensors to the vehicle manufacturing cloud system 102 directly. The AVM algorithm 112c is configured to communicate information and/or instructions to the wireless transmission module 120 received from the infrastructure system 108 and/or the vehicle manufacturing cloud system 102.

The vehicle central gateway module 122 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 134. The vehicle central gateway module 122 is configured to distribute data communicated to the vehicle central gateway module 122 by each of the various domain bus systems to other components of the autonomous vehicle 110. The vehicle central gateway module 122 is also configured to distribute information received from the AVM algorithm 112c to the various domain bus systems. The vehicle central gateway module 122 is further configured to send information to the AVM algorithm 112c received from the various domain bus systems. For example, the autonomous vehicle 110 utilizes the AVM algorithm 112c to process and send information received from the vehicle central gateway module 122 to the infrastructure system 108. As another example, the autonomous vehicle 110 utilizes the AVM algorithm 112c to process and send information received from the vehicle central gateway module 122 to the vehicle manufacturing cloud system 102 directly. The AVM algorithm 112c is configured to communicate information and/or instructions to the vehicle central gateway module 122 received from the infrastructure system 108 and/or the vehicle manufacturing cloud system 102.

The vehicle infotainment system 124 is a system that delivers a combination of information and entertainment content and/or services to an operator 146 of the autonomous vehicle 110. It is understood that the vehicle infotainment system 124 can deliver entertainment content to the operator 146 of the autonomous vehicle 110, in some examples. It is also understood that the vehicle infotainment system 124 can deliver information services to the operator 146 of the autonomous vehicle 110, in some examples. In one or more examples, the vehicle infotainment system 124 includes built-in car computers that combine one or more functions, such as digital radios, built-in cameras, and/or televisions. The vehicle infotainment system 124 communicates information associated with the built-in car computers or processors to the AVM algorithm 112c. For example, the autonomous vehicle 110 utilizes the AVM algorithm 112c to process and send information received from the vehicle infotainment system 124 to the infrastructure system 108. As another example, the autonomous vehicle 110 utilizes the AVM algorithm 112c to process and send information received from the vehicle infotainment system 124 to the vehicle manufacturing cloud system 102 directly. The AVM algorithm 112c is configured to communicate information and/or instructions to the vehicle infotainment system 124 received from the infrastructure system 108 and/or the vehicle manufacturing cloud system 102.

The one or more vehicle sensors 126 may be, for example, one or more of cameras, lidar, radar, and/or ultrasonic devices. For example, ultrasonic devices utilized as the one or more vehicle sensors 126 emit a high frequency sound wave that hits an object (e.g., a wall or another vehicle) and is then reflected back to the autonomous vehicle 110. Based on the amount of time it takes for the sound wave to return to the autonomous vehicle 110, the autonomous vehicle 110 can determine the distance between the one or more vehicle sensors 126 and the object. As another example, camera devices utilized as the one or more vehicle sensors 126 provide a visual indication of a space around the autonomous vehicle 110. As an additional example, radar devices utilized as the one or more vehicle sensors 126 emit electromagnetic wave signals that hit the object and is then reflected back to the autonomous vehicle 110. Based on the amount of time it takes for the electromagnetic waves to return to the autonomous vehicle 110, the autonomous vehicle 110 can determine a range, velocity, and angle of the autonomous vehicle 110 relative to the object.

The one or more vehicle sensors 126 communicate information associated with the position and/or distance at which the autonomous vehicle 110 is relative to the object to the AVM algorithm 112c. For example, the autonomous vehicle 110 utilizes the AVM algorithm 112c to process and send information received from the one or more vehicle sensors 126 to the infrastructure system 108. As another example, the autonomous vehicle 110 utilizes the AVM algorithm 112c to process and send information received from the one or more vehicle sensors 126 to the vehicle manufacturing cloud system 102 directly. The AVM algorithm 112c is configured to communicate information and/or instructions to the one or more vehicle sensors 126 received from the infrastructure system 108 and/or the vehicle manufacturing cloud system 102.

The vehicle battery 128 is controlled by a battery management system (not shown) that provides instructions to the vehicle battery 128. For example, the battery management system provides instructions to the vehicle battery 128 based on a temperature of the vehicle battery 128. The battery management system ensures acceptable current modes of the vehicle battery 128. For example, the acceptable current modes protect against overvoltage, overcharge, and/or overheating of the vehicle battery 128. As another example, the temperature of the vehicle battery 128 indicates to the battery management system whether any of the acceptable current modes are within acceptable temperate ranges. The battery management system associated with the vehicle battery 128 communicates information associated with the temperature of the vehicle battery 128 to the AVM algorithm 112c. For example, the autonomous vehicle 110 utilizes the AVM algorithm 112c to process and send information received regarding the vehicle battery 128 to the infrastructure system 108. As another example, the autonomous vehicle 110 utilizes the AVM algorithm 112c to process and send information regarding the vehicle battery 128 to the vehicle manufacturing cloud system 102 directly. The AVM algorithm 112c is configured to communicate information and/or instructions to the vehicle battery 128 received from the infrastructure system 108 and/or the vehicle manufacturing cloud system 102.

The vehicle GNSS 130 is configured to communicate with satellites so that the autonomous vehicle 110 can determine a specific location of the autonomous vehicle 110. The vehicle navigation maps 132 can display, via a display screen (not shown), the specific location of the autonomous vehicle 110 to the operator 146. The vehicle GNSS 130 communicates geographical information associated with the autonomous vehicle 110 to the AVM algorithm 112c. For example, the autonomous vehicle 110 utilizes the AVM algorithm 112c to process and send information received from the vehicle GNSS 130 to the infrastructure system 108. As another example, the autonomous vehicle 110 utilizes the AVM algorithm 112c to process and send information from the vehicle GNSS 130 to the vehicle manufacturing cloud system 102 directly. The AVM algorithm 112c is configured to communicate information and/or instructions to the vehicle GNSS 130 received from the infrastructure system 108 and/or the vehicle manufacturing cloud system 102. As another example, the autonomous vehicle 110 utilizes the AVM algorithm 112c to process and send information associated with the vehicle navigation maps 132 to the infrastructure system 108. As another example, the autonomous vehicle 110 utilizes the AVM algorithm 112c to process and send information from the vehicle navigation maps 132 to the vehicle manufacturing cloud system 102 directly. The AVM algorithm 112c is configured to communicate information and/or instructions to the vehicle navigation maps 132 received from the infrastructure system 108 and/or the vehicle manufacturing cloud system 102.

The vehicle delivery manager cloud system 104 wirelessly communicates (e.g., receives and/or sends instructions and/or information) with one or more of a rental agencies cloud system 136, a valet parking agencies cloud system 138, an insurance agencies cloud system 140, and/or a dealership 142. For example, the vehicle delivery manager cloud system 104 can facilitate the delivery of the one or more autonomous vehicles to any of the rental agencies cloud system 136, the valet parking agencies cloud system 138, the insurance agencies cloud system 140, and/or the dealership 142. The vehicle delivery manager cloud system 104 also wirelessly communicates with the vehicle customer web-portal account cloud system 106. It should be understood that other cloud systems can be included in one or more examples.

The vehicle delivery manager cloud system 104 wirelessly communicates with a user device 144 such as a mobile device, a display panel, and/or a computer. The autonomous vehicle 110 also wirelessly communicates directly with the user device 144. As an example, the autonomous vehicle 110 is configured to process information and/or instructions received from the user device 144. For example, the operator 146 engages with the user device 144 via an application that organizes any information and/or instructions received from the vehicle customer web-portal account cloud system 106 and/or the autonomous vehicle 110. As another example, the operator 146 may send one or more instructions to the vehicle customer web-portal account cloud system 106 such as making a selection of which vehicle the operator 146 would like to receive from any of a rental agency (not shown) associated with the rental agencies cloud system 136, a valet parking agency (not shown) associated with the valet parking agencies cloud system 138, an insurance agency (not shown) associated with the insurance agencies cloud system 140, and/or the dealership 142.

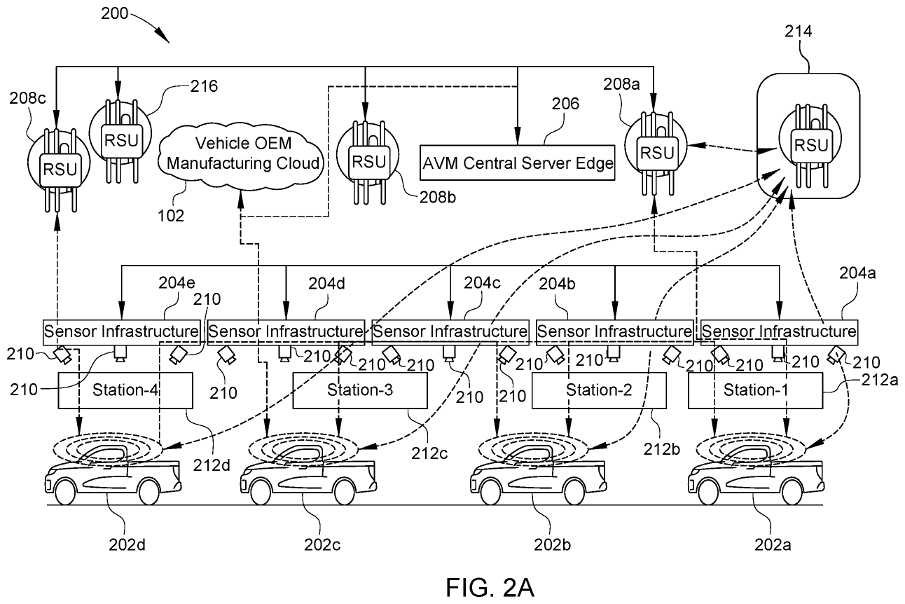

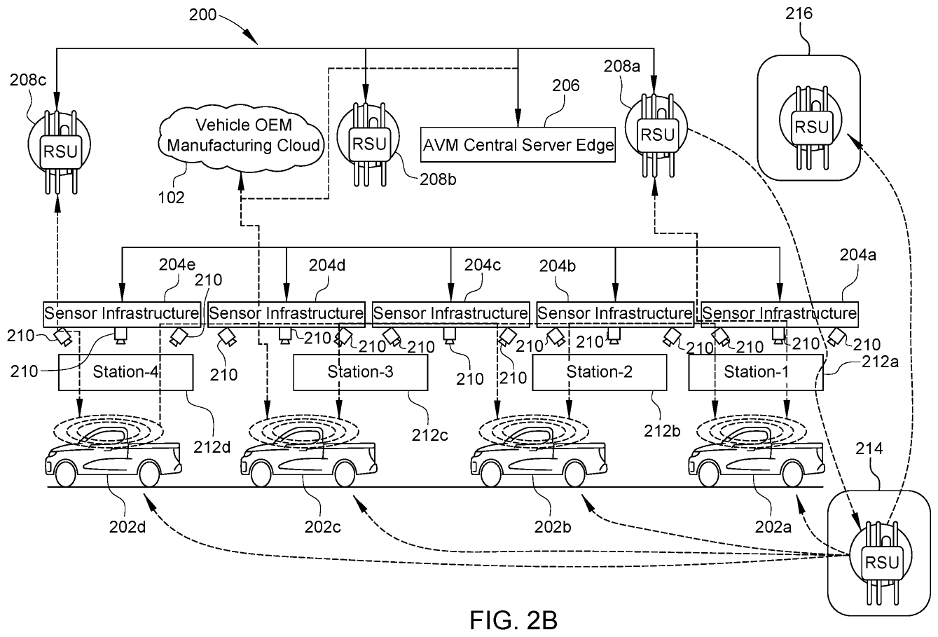

FIG. 2A is illustrative of the example manufacturing environment 200 that facilitates an engagement (e.g., the communicative coupling) of one or more autonomous vehicles 202a-202d (e.g., the autonomous vehicle 110) with one or more infrastructure systems 204a-204e (e.g., the infrastructure system 108). For example, the manufacturing environment 200 is located inside or associated with a manufacturing plant. Generally, an AVM central server edge 206 (e.g., an edge processor) is connected to one or more road-side units (RSUs) 208a-208c and functionally operates in a similar manner as the infrastructure controller 118 (e.g., the AVM central server edge 206 effectively extends an actionable coverage of the infrastructure controller 118). For example, the AVM central server edge 206 is connected to the one or more RSUs 208a-208c by a wireless means, a wired means, or a combination thereof. The AVM central server edge 206 is also connected to one or more infrastructure systems 204a-204e. For example, the AVM central server edge 206 is connected to the one or more infrastructure systems 204a-204e by a wireless means, a wired means, or a combination thereof. As an example, the AVM central server edge 206 is configured receive one or more signals from the one or more RSUs 208a-208c and/or from the one or more infrastructure systems 204a-204e while communicating with the vehicle manufacturing cloud system 102.

The AVM central server edge 206 is configured to utilize sensor data received from the one or more infrastructure systems 204a-204e to determine a location of any of the one or more autonomous vehicles 202a-202d. Each of the one or more infrastructure systems 204a-204e include a set of infrastructure sensors 210 (e.g., the one or more sensors 114) such as, for example, a two-dimensional (2D) camera, a three-dimensional (3D) camera, an infrared sensor, a radar scanner, a laser scanner, a light detection and ranging (LIDAR) sensor, an ultrasonic sensor, among others. The set of infrastructure sensors 210 monitor the movement of each of the one or more autonomous vehicles 202a-202d as the one or more autonomous vehicles 202a-202d move through the environment, as also described in connection with FIG. 1.

In one or more examples, the sensor data is generated based on the type of monitoring being performed by the set of infrastructure sensors 210 (e.g., the movement of each of the one or more autonomous vehicles 202a-202d or the environment itself). In one form, the one or more infrastructure systems 204a-204e provide pose, routing, and obstacle data of an environment to the AVM central server edge 206.

The AVM central server edge 206 is further configured to utilize the one or more RSUs 208a-208c to facilitate communication between the AVM central server edge 206 and any of the one or more autonomous vehicles 202a-202d. The one or more RSUs 208a-208c are equipped with a cellular vehicle-to-infrastructure communication system (referred to as “CV2X systems”). As an example, the one or more RSUs 208a-208c are equipped with a PC5-based CV2X that employs radio frequency (RF) sidelink communication for low latency vehicle sensor connectivity.

Each of the one or more RSUs 208a-208c are configured to receive one or more infrastructure-side data packets from the AVM central server edge 206. Generally, each of the one or more RSUs 208a-208c can include various components for performing the operations described herein, such as, but not limited to, transceivers, processor circuits, memory circuits, routers, and/or input/output interface hardware. For example, the one or more infrastructure-side data packets can include one or more instructions, one or more signals, or a combination thereof. Each of the one or more RSUs 208a-208c are further configured to broadcast the one or more infrastructure-side data packets to any of the one or more autonomous vehicles 202a-202d within range of the one or more RSUs 208a-208c. As another example, the one or more infrastructure-side data packets are generated from one or more park control infrastructure messages (PCIMs). As another example, each of the one or more RSUs 208a-208c are configured to broadcast the one or more infrastructure-side data packets via one or more wireless communication protocols, such as a CV2X protocol, a private and/or public cellular protocol, a Wi-Fi protocol, a long range (LoRA) signal protocol, a Bluetooth protocol, and/or a UWB protocol.

Each of the one or more RSUs 208a-208c are further configured to receive one or more vehicle-side data packets including one or more park control vehicle messages (PCVMs) from any of the one or more autonomous vehicles 202a-202d. Each of the one or more RSUs 208a-208c are additionally configured to forward the one or more vehicle-side data packets to the AVM central server edge 206.

Further illustrated in FIG. 2A is a plurality of workstations 212a-212d. Each workstation of the plurality of workstations 212a-212d are representative of various assembly points in a manufacturing facility. For example, each of the workstations of the plurality of workstations 212a-212d may specifically correspond (e.g., be associated with) to one or more particular infrastructure systems of the one or more infrastructure systems 204a-204e. As an example, the infrastructure system 204a corresponds to the workstation 212a. As another example, the infrastructure system 204b corresponds to the workstation 212b. As an additional example, the infrastructure systems 204c and 204d correspond to the workstation 212c. As yet another example, the infrastructure system 204e corresponds to the workstation 212d. It should be appreciated that multiple systems can correspond to one workstation and/or multiple workstations can correspond to one system, as well as other combinations.

As the one or more autonomous vehicles 202a-202d progress through the environment and pass each of the plurality of workstations 212a-212d, each of the one or more autonomous vehicles 202a-202d receive one or more broadcasted marshaling messages from the AVM central server edge 206, via the one or more RSUs 208a-208c. In an instance wherein a third party 214 is present in the manufacturing environment 200, the third party 214 can also receive the one or more broadcasted marshaling messages transmitted from the AVM central server edge 206. In this particular example, the third party 214 is a malicious actor device. While the third party 214 is depicted as an RSU in FIG. 2, it is understood that the third party can be different device types or components, such as an on-board unit associated with a vehicle, a mobile device, or any other type of device.

In various applications, for example, the third party 214 can perform one or more variations of a man-in-the-middle attack wherein the third party 214 causes the broadcasted one or more marshaling messages received from the AVM central server edge 206 to be manipulated (e.g., altered or modified). The third party 214 is able to manipulate the broadcasted one or more marshaling messages because the third party 214 is configured to intercept the broadcasted one or more marshaling messages before the broadcasted one or more marshaling message are received at the one or more autonomous vehicles 202a-202d. It should be appreciated that the third party 214 can use different techniques to intercept or capture the broadcasted marshaling messages.

The manipulation to the broadcasted one or more marshaling messages can occur upon receipt of the broadcasted one or more marshaling messages at the third party 214. Once the broadcasted one or more marshaling messages have been manipulated, the third party 214 is configured to broadcast the one or more manipulated messages to the one or more autonomous vehicles 202a-202d. As an example, the third party 214 can manipulate the broadcasted one or more marshaling messages by creating a delay in the receipt of the broadcasted one or more marshaling messages at the one or more autonomous vehicles 202a-202d. As another example, the third party 214 can manipulate the broadcasted one or more marshaling messages by sending repetitive messages that may cause confusion (e.g., difficulty in processing the messages) at the one or more autonomous vehicles 202a-202d. As an additional example, the third party 214 can also broadcast a completely different message to the one or more autonomous vehicles 202a-202d.

FIG. 2B is illustrative of the example manufacturing environment 200 inclusive of an additional RSU that operates as a data sniffer device 216. The data sniffer device 216 is configured to wirelessly monitor any broadcasted messages transmitted to the one or more autonomous vehicles 202a-202d via any RSUs within range of the data sniffer device 216. As an example, each of the one or more RSUs 208a-208c and the data sniffer device 216 can be wired to the AVM central server edge as an interconnected backend network. The data sniffer device 216 is also configured to communicate any findings (e.g., intercepted messages or data) to the AVM central server edge 206. For example, the findings are associated with the data sniffer device's 216 monitoring of any broadcasted messages transmitted to the one or more autonomous vehicles 202a-202d. In various examples, the data sniffer device 216 is any hardware and/or software device that allows for “sniffing” or monitoring of data traffic and/or capturing the data traffic (e.g., capturing data packets or data flow to and/or from the one or more autonomous vehicles 202a-202d).

The AVM central server edge 206 is configured to receive any findings from the data sniffer device 216. For example, the findings can include data indicative of an origination of a message, whether the message has any malicious content therein, the message itself, or a combination thereof. However, it is understood that the data can indicate any information associated with the message. The AVM central server edge 206 is also configured to communicate with either the infrastructure system 108 and/or the vehicle manufacturing cloud system 102 to utilize an infrastructure-side AVM algorithm (e.g., the AVM algorithms 112a and/or 112b) to analyze the findings. However, it is understood that the AVM central server edge 206 may have an AVM algorithm disposed therein, which may also operate as an infrastructure-side AVM algorithm.

The infrastructure-side AVM algorithm is configured to verify that the data received from the data sniffer device 216 matches a broadcasted message originally transmitted by the AVM central server edge 206. As an example, the infrastructure-side AVM algorithm is also configured to verify that the data received from the data sniffer device 216 matches a broadcasted message originally transmitted by the one or more RSUs 208a-208c. For example, the infrastructure-side AVM algorithm is configured to verify that the data received from the data sniffer device 216 matches the broadcasted message originally transmitted by the AVM central server edge 206 and within a defined timeframe. As an example, the verification of whether the data received from the data sniffer device 216 matches the broadcasted message originally transmitted by the AVM central server edge 206 includes, in part, whether the data was received by the data sniffer device 216 within an expected timeframe. As another example, the expected timeframe represents a time period between when a message is sent from the AVM central server edge 206 to be broadcasted by the one or more RSUs 208a-208c and when the broadcasted message is expected to be received by the data sniffer device 216 (e.g., a time period threshold).

In a case wherein the infrastructure-side AVM algorithm verifies an existence of a malicious actor device (e.g., the third party 214), the infrastructure-side AVM algorithm can cause an alert to be transmitted to the AVM central server edge 206, the vehicle manufacturing cloud system 102, and/or any human operators (e.g., the operator 146) in the vicinity of the manufacturing environment. For example, the verification of the existence of the malicious actor device can be a mismatch between the message sent from the AVM central server edge 206 and the message received at the data sniffer device 216, a delay in the message received at the data sniffer device 216, and/or an entirely new message that is received at the data sniffer device 216 relative to the message sent from the AVM central server edge 206, among other verifications.

In an example embodiment, the AVM central server edge 206 is configured to generate and/or learn a channel (e.g., using machine learning) busy ratio (CBR) for one or more sanitized operating scenario(s). As an example, the one or more sanitized operating scenario(s) are operations that may be considered to be normal operations and/or operations known to be non-malicious. For example, the CBR is used as an RF fingerprint so that any replay attached by a malicious actor device (e.g., the third party 214) may be detected. As another example, any broadcasted message is compared to the CBR. The infrastructure-side algorithm is configured to compare the CBR and the broadcasted message to determine whether the broadcasted message matches any of the one or more sanitized operating scenarios. In an instance where the infrastructure-side algorithm determines that the CBR and the broadcasted message do not match, then the broadcasted message is considered to be a detected replay attack. The AVM central server edge 206 can also store information relating to a total number of active CV2X radios in the manufacturing environment 200. For example, the AVM central server edge 206 can store the total number of active CV2X radios in the manufacturing environment 200 in a database that is either disposed locally within the AVM central server edge 206 or externally relative to the AVM central server edge 206. As another example, the active CV2X radios may form part of any of the one or more autonomous vehicles 202a-202d and/or the one or more RSUs 208a-208c. However, it is understood that the active CV2X radios may be disposed in any receiving/transmitting device in the manufacturing environment 200, for example. For example, the CV2X radio associated with any exchanged message between any receiving/transmitting device in the manufacturing environment 200 is a basis by which the infrastructure-side algorithm can detect a replay attack. As another example, the CV2X radio associated with any exchanged message between any receiving/transmitting device in the manufacturing environment 200 may be utilized by the infrastructure-side algorithm as an input parameter to identify any changes in the CBR (e.g., caused by the malicious actor device) in any particular zone within the manufacturing environment 200 and/or the entirety of the manufacturing environment 200 as a whole.

The infrastructure-side AVM algorithm can deploy one or more preventative measures to reduce instances of any replay attacks in the manufacturing environment 200. For example, the infrastructure-side AVM algorithm can cause the AVM central server edge to direct the one or more RSUs 208a-208c to randomly change a data rate associated with each of the one or more RSUs 208a-208c. For example, the randomization of the data rate associated with each of the one or more RSUs 208a-208c aids the infrastructure-side AVM algorithm to isolate and/or identify the replayed data and/or the associated attacker causing or initiating the replay attack. For example, the AVM central server edge 206 can also randomize the ProSe per packet priority (PPPP) and/or the modulation and coding scheme (MCS) to aid in the identification of the associated attacker causing or initiating the replay attack. Additionally, the infrastructure-side AVM algorithm can narrow down a location of the associated attacker based on a received signal strength of the messages that have been identified as a replay attack. For example, the infrastructure-side AVM algorithm can pinpoint a source of the signal associated with the replay attack using trilateration methods.

Regardless of how the replay attack is detected, the infrastructure-side AVM algorithm can cause one or more post-detection measures to be initiated in an instance wherein the replay attack is detected. For example, the infrastructure-side AVM algorithm can cause the AVM central server edge 206 to trigger a global pause in operation or a zonal pause in operation of the one or more autonomous vehicles 202a-202d. The AVM central server edge 206 can also identify targeted vehicles of the one or more autonomous vehicles 202a-202d. Additionally, the AVM central server edge 206 can triangulate the location of the associated attacker. For example, the AVM central server edge 206 can utilize interference from the data sniffer device 216, the specific RSU of the one or more RSUs 208a-208c being attacked, and/or an on-board unit of the vehicle associated with the offending broadcasted message to triangulate the location of the associated attacker. As another example, the AVM central server edge 206 can triangulate the location of the associated attacker using RSSI methods.

In another example embodiment, each of the one or more autonomous vehicles 202a-202d are also configured to detect any relay attacks. For purposes of explanation, and illustrative of an example, the vehicle-side AVM algorithm (e.g., the AVM algorithm 112c) of a single autonomous vehicle of the one or more autonomous vehicles 202a-202d is configured to perform a statistical probabilistic analysis of when any messages transmitted and/or received in the manufacturing environment 200 are likely to have been replayed and/or delayed. As another example, the vehicle-side AVM algorithm is configured to monitor PCIM data patterns associated with each of the one or more RSUs 208a-208c. As an additional example, the vehicle-side AVM algorithm's monitoring of the PCIM data patterns enable the probabilistic analysis to be performed. However, it is understood that all of the autonomous vehicles of the one or more autonomous vehicles 202a-202d are configured to utilize a respective vehicle-side AVM algorithm to perform the probabilistic analysis in some examples.

Each of the one or more autonomous vehicles 202a-202d utilize a respective on-board unit (not shown) to detect any malicious messages. For example, the respective on-board units can compare each message transmitted and/or received by any of the one or more autonomous vehicles 202a-202d to a respective broadcast history associated with each of the one or more autonomous vehicles 202a-202d. As an example, the broadcast history corresponds to historic messages transmitted and/or received from/to each of the one or more autonomous vehicles 202a-202d.

Thus, the vehicle-side AVM algorithm can cause one or more post-detection measures to be initiated in an instance wherein a replayed message is detected. For example, the vehicle-side AVM algorithm can alert the AVM central server edge 206, the vehicle manufacturing cloud system 102, and/or any human operators (e.g., the operator 146) of the detected replay attack. As another example, the vehicle-side AVM algorithm can also change an outgoing data rate for any number of messages that are broadcasted by any of the one or more autonomous vehicles 202a-202d. As an additional example, vehicle-side AVM algorithm can further enable a triggering of a pause in operation of an affected vehicle (e.g., an autonomous vehicle that has received a replayed message). As yet another example, the vehicle-side AVM algorithm can cause for the vehicle's respective broadcasting data patterns (e.g., data rate, PPPP, MCS, and/or packet size) to be transmitted to the AVM central server edge 206 so that the AVM central server edge 206 may cross-reference the received vehicle data patterns against received PCVM messages. For example, the vehicle-side AVM algorithm is configured to recognize any statistical anomalies present within any messages transmitted/received by any nearby (e.g., adjacently positioned) vehicles.

As another example, the vehicle-side AVM algorithm is configured to recognize the statistical anomalies present within the messages based on the vehicle-side AVM algorithm monitoring the transmitted/received by the nearby vehicles. As yet another example, the statistical anomalies can include altered data rates associated with the messages, sudden jumps in signal strength associated with the messages, or a combination thereof. It is understood, however, that the statistical anomalies can be any metric associated with the messages, for example. As an additional example, the vehicle-side AVM algorithm can provide an audio-visual alert in the instance wherein the replayed message is detected such as flashing lights of the vehicle, honking horn(s) of the vehicle, rolling windows up and/or down of the vehicle, or a combination thereof. However, it is understood that the vehicle-side AVM algorithm can alert the AVM central server edge 206 of the detected replayed message in any other way.

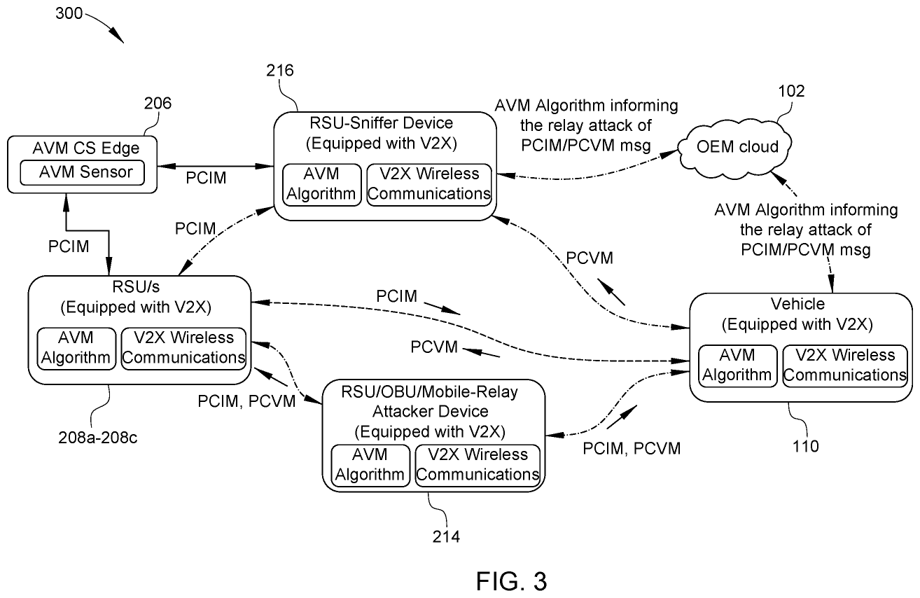

FIG. 3 depicts an example flow of communication between each of the vehicle manufacturing cloud system 102, the AVM central server edge 206, the one or more RSUs 208a-208c, the third party 214, the data sniffer device 216, and the autonomous vehicle 110. As an example, each of the one or more RSUs 208a-208c, the third party 214, the data sniffer device 216, and the autonomous vehicle 110 have respective AVM algorithm components and V2X wireless communication components disposed therein that support the communication between each of the third party 214, the data sniffer device 216, and the autonomous vehicle 110.

The infrastructure-side AVM algorithm supports the data-integrity of an overall infrastructure associated with the manufacturing environment 200 by validating one or more PCIM-related data elements relative to an original data source derived from the AVM central server edge 206. For example, the one or more PCIM-related data elements can be compared to data associated with any messages transmitted from the AVM central server edge 206 to the one or more autonomous vehicles 202a-202d, via the one or more RSUs 208a-208c. As another example, the one or more PCIM-related data elements can include a vehicle identifier, a message generation time, a rolling counter, driving permission(s), drive command(s), a control interface, or a combination thereof. As an additional example, the vehicle identifier is unique to each of the respective one or more autonomous vehicles 202a-202d. As yet another example, the message generation time can indicate an absence of a replayed message if the message generation time satisfies a predefined threshold (e.g., falls below the predefined threshold). As a further example, the rolling counter will reflect a history of randomized resets in the absence of any replayed messages. As yet another example, data elements associated with the drive permission(s) will be consistent with past, current, and/or future messages in the absence of any replayed messages. As a further example, data elements associated with the drive command(s) will be consistent with past, current, and/or future messages in the absence of any replayed messages. As an additional example, data elements associated with the drive permission(s) particularly related to a path snippet, direct control of the vehicle, and/or a trajectory control of the vehicle will be consistent with past, current, and/or future messages in the absence of any replayed messages.

The vehicle-side AVM algorithm supports the data-integrity of the overall infrastructure associated with the manufacturing environment 200 by validating one or more PCVM-related data elements relative to an original data source derived from the AVM central server edge 206. For example, the one or more PCVM-related data elements can be compared to data associated with any messages transmitted from the AVM central server edge 206 to the one or more autonomous vehicles 202a-202d, via the one or more RSUs 208a-208c. As another example, the one or more PCVM-related data elements can include a vehicle identifier, a message generation time, a rolling counter, a state of the vehicle, driving parameters, vehicle parameters, or a combination thereof. As an additional example, the vehicle identifier is unique to each of the respective one or more autonomous vehicles 202a-202d. As yet another example, the message generation time can indicate an absence of a replayed message if the message generation time satisfies a predefined threshold. As a further example, the rolling counter will reflect a history of randomized resets in the absence of any replayed messages. As yet another example, data elements associated with the state of the vehicle will be consistent with past, current, and/or future messages in the absence of any replayed messages. As an additional example, data elements associated with the drive permission(s) particularly related to velocity, curvature, and/or odometry relative to the vehicle will be consistent with past, current, and/or future message in the absence of any replayed messages. As another example, data elements associated with the drive permission(s) particularly related to vehicle feedback, vehicle error(s), vehicle debugging, and/or vehicle recognition data relative to the vehicle will be consistent with past, current, and/or future message in the absence of any replayed messages.

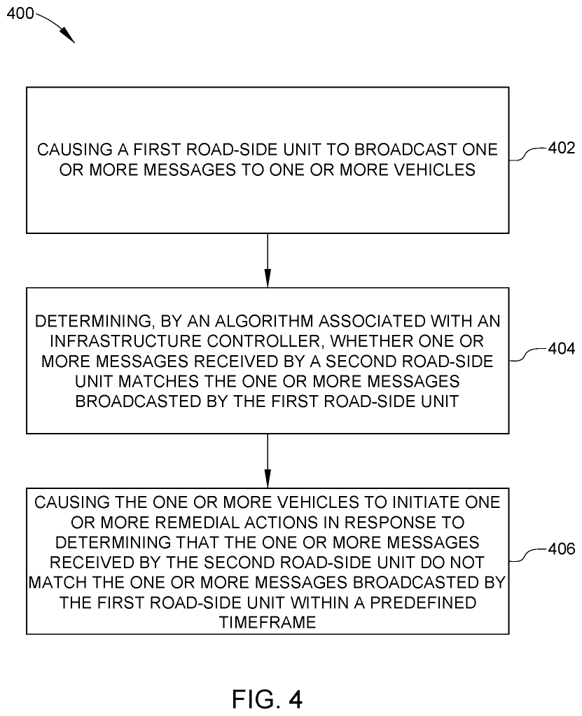

FIG. 4 is a flowchart illustrating an example method 400 for detecting a third party (e.g., the third party 214) in a marshaling setting. However, it is understood that the process described by the method 400 may be implemented to detect the third party in any setting. At operation 402, a first road-side unit (e.g., the first road-side unit 208a) is caused to broadcast one or more messages. For example, the first road-side unit is caused to broadcast the one or more messages to one or more vehicles (e.g., the autonomous vehicle 110). As another example, an infrastructure controller (e.g., the infrastructure controller 118) causes the first road-side unit to broadcast the one or more messages to the one or more vehicles.

At operation 404, a determination is made regarding whether one or more messages received by a second road-side unit (e.g., the data sniffer device 216) matches the one or more messages broadcasted by the first road-side unit. For example, the determination of whether the one or more messages received by the second road-side unit matches the one or more messages broadcasted by the first road-side unit is made by an algorithm (e.g., the AVM algorithm 112b) associated with the infrastructure controller.

At operation 406, the one or more vehicles are caused to initiate one or more remedial actions. For example, the one or more vehicles are caused to initiate one or more remedial action in response to determining that the one or more messages received by the second road-side unit do not match the one or more messages broadcasted by the first road-side unit within a predefined timeframe. It is understood that the one or more vehicles are caused to initiate one or more remedial action in response to determining that the one or more messages received by the second road-side unit do not match the one or more messages broadcasted by the first road-side unit based on any metric and can be outside of the timeframe as well, for example. As a further example, the one or more remedial actions can include triggering a global pause in operation of all of the one or more vehicles, triggering a zonal pause in operation of a subset of the one or more vehicles, identifying one or more targeted vehicles of the one or more vehicles, triangulating a location of a third party, or a combination thereof. For example, the triangulation of the third party is performed via one or more received signal strength indicator triangulation methods. As another example, the third party is a malicious actor device that can be, but is not limited to, a road-side unit, an on-board unit associated with a vehicle, or a mobile device.

In an example embodiment, the second road-side unit is caused to validate the one or more messages. For example, the infrastructure controller causes the second road-side unit to validate the one or more messages. As another example, the second road-side unit is configured to receive the one or more messages based on a location of the first road-side unit. In another example embodiment, one or more instructions are caused to be transmitted to one or more road-side units. For example, the one or more road-side units include at least the first road-side unit and the second road-side unit. As another example, the validation of the one or more messages is based on the one or more messages matching one or more sanitized operating scenarios defined by a channel busy ratio.

In yet another example embodiment the one or more road-side units are caused to randomly change a data rate. For example, the data rate is associated with each of the one or more road-side units. As another example, the data rate is based on the one or more instructions. As yet another example, the one or more road-side units are caused to isolate and/or identify replayed data. As another example, the replayed data is associated with the one or more messages broadcasted by the first road-side unit based on the one or more instructions. As an additional example, the one or more road-side units are caused to isolate and/or identify a location of the third party. For example, the identification of the third party is based on a signal strength of the one or more road-side units.

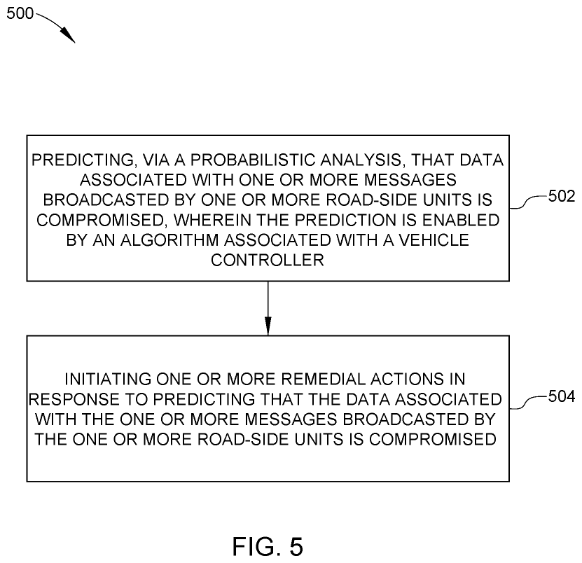

FIG. 5 is another flowchart illustrating an example method 500 for detecting a third party (e.g., the third party 214) in a marshaling setting. However, it is understood that the process described by the method 500 may be implemented to detect the third party in any setting. At operation 502, data associated with one or more messages is predicted to be compromised. As an example, the data associated with one or more messages may be determined to likely be compromised. For example, the data is predicted using a probabilistic analysis. As another example, the data is broadcasted by one or more road-side units (e.g., the one or more road-side units 208a-208c). As an additional example, the prediction is enabled by an algorithm (e.g., the algorithm 112c) associated with a vehicle controller.

At operation 504, one or more remedial actions are initiated in response to predicting that the data associated with the one or more messages broadcasted by the one or more road-side units is compromised. For example, the one or more remedial actions are initiated by the vehicle controller. As another example, the one or more remedial actions can include triggering a pause in operation of the vehicle, transmitting an alert, adjusting one or more outgoing data patterns associated with one or more messages broadcasted from the vehicle, or a combination thereof. As an additional example, the alert can be transmitted to a central server (e.g., the AVM central server edge 206), a vehicle manufacturing cloud system (e.g., the vehicle manufacturing cloud system 102), one or more operators (e.g., the operator 146), or a combination thereof. As a further example, the one or more outgoing data patterns can include a data rate, a PPPP, a MCS, a packet size, or a combination thereof. As yet another example, the one or more outgoing data patterns are cross-referenced against the one or more messages broadcasted from the vehicle.

In an example embodiment, a determination is made regarding whether one or more messages broadcasted from the vehicle match a broadcast history associated with the vehicle. For example, the determination of whether the one or more messages broadcasted from the vehicle match the broadcast history associated with the vehicle is made by the vehicle controller. In another example embodiment, the one or more remedial actions are initiated in response to determining that the one or more messages broadcasted from the vehicle do not match the broadcast history. For example, the initiation of the one or more remedial actions is made by the vehicle controller.

In yet another example embodiment, one or more messages broadcasted by one or more adjacent vehicles are identified. For example, the one or more messages broadcasted by the one or more adjacent vehicles can include an alteration of a data rate, a jump in a signal strength, or a combination thereof. As another example, an alert is transmitted to the central server. As an additional example, the alert is transmitted to the central server based on the identification of the one or more messages broadcasted by the one or more adjacent vehicles.

Thus, one or more examples of the present disclosure provide a means for identifying, detecting, and/or communication of a malicious actor device via the utilization of systems and methods enabled by an infrastructure-side algorithm and/or a vehicle-side algorithm. For example, detection of the malicious actor device in real-time allows for quick isolation of any replayed messages, quick identification of the source of any replayed messages, and/or efficient mitigation associated with handling any compromised vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
causing, by an infrastructure controller, a first road-side unit to broadcast one or more messages to one or more vehicles;
determining, by an algorithm associated with the infrastructure controller, whether one or more messages received by a second road-side unit matches the one or more messages broadcasted by the first road-side unit; and
causing, by the infrastructure controller, the one or more vehicles to initiate one or more remedial actions in response to determining that the one or more messages received by the second road-side unit do not match the one or more messages broadcasted by the first road-side unit within a predefined timeframe.

2. The method of claim 1, further comprising:
causing, by the infrastructure controller, the second road-side unit to validate the one or more messages, wherein the second road-side unit is configured to receive the one or more messages based on a location of the first road-side unit, and wherein the validation of the one or more messages is based on the one or more messages matching one or more sanitized operating scenarios defined by a channel busy ratio.

3. The method of claim 1, wherein the one or more remedial actions include:
triggering a global pause in operation of all of the one or more vehicles;
triggering a zonal pause in operation of a subset of the one or more vehicles;
identifying one or more targeted vehicles of the one or more vehicles; or
triangulating, via one or more received signal strength indicator triangulation methods, a location of a third party, wherein the third party is a road-side unit, an on-board unit associated with a vehicle, or a mobile device.

4. The method of claim 1, further comprising:
causing, by the algorithm, one or more instructions to be transmitted to one or more road-side units, wherein the one or more road-side units include at least the first road-side unit and the second road-side unit.

5. The method of claim 4, further comprising:
causing the one or more road-side units to randomly change a data rate associated with each of the one or more road-side units based on the one or more instructions;
causing the one or more road-side units to isolate and identify replayed data associated with the one or more messages broadcasted by the first road-side unit based on the one or more instructions; or
causing the one or more road-side units to isolate and identify a location of a third party, wherein the identification of the location of the third party is based on a signal strength of the one or more road-side units, and wherein the third party is a road-side unit, an on-board unit associated with a vehicle, or a mobile device.

6. A method comprising:
predicting, via a probabilistic analysis, that data associated with one or more messages broadcasted by one or more road-side units is compromised, wherein the prediction is enabled by an algorithm associated with a vehicle controller; and
initiating, by the vehicle controller, one or more remedial actions in response to predicting that the data associated with the one or more messages broadcasted by the one or more road-side units is compromised.

7. The method of claim 6, further comprising:
determining, by the vehicle controller, whether one or more messages broadcasted from the vehicle match a broadcast history associated with the vehicle.

8. The method of claim 7, further comprising:
initiating, by the vehicle controller, the one or more remedial actions in response to determining that the one or more messages broadcasted from the vehicle does not match the broadcast history.

9. The method of claim 8, wherein the one or more remedial actions include:
triggering a pause in operation of the vehicle;
transmitting an alert to a central server, a vehicle manufacturing cloud system, one or more operators, or a combination thereof; or
adjusting one or more outgoing data patterns associated with one or more messages broadcasted from the vehicle, wherein the one or more outgoing data patterns include a data rate, a ProSe per packet priority, a modulation and coding scheme, a packet size, or a combination thereof.

10. The method of claim 9, wherein the one or more outgoing data patterns are cross-referenced against the one or more messages broadcasted from the vehicle.

11. The method of claim 6, further comprising:
identifying one or more messages broadcasted by one or more adjacent vehicles, wherein the one or more messages broadcasted by the one or more adjacent vehicles include an alteration of a data rate, a jump in a signal strength, or a combination thereof; and
transmitting an alert to a central server based on the identification of the one or more messages broadcasted by the one or more adjacent vehicles.

12. A system comprising:
an infrastructure controller configured to:
cause a first road-side unit to broadcast one or more messages to one or more vehicles,
determine, by an algorithm associated with the infrastructure controller, whether one or more messages received by a second road-side unit matches the one or more messages broadcasted by the first road-side unit, and
cause the one or more vehicles to initiate a first set of remedial actions in response to determining that the one or more messages received by the second road-side unit do not match the one or more messages broadcasted by the first road-side unit within a predefined timeframe; and
a vehicle controller configured to:
predict, via a probabilistic analysis, that data associated with one or more messages broadcasted by one or more road-side units is compromised, wherein the prediction is enabled by an algorithm associated with the vehicle controller, and
initiate a second set of remedial actions in response to predicting that the data associated with the one or more messages broadcasted by the one or more road-side units is compromised.

13. The system of claim 12, wherein the infrastructure controller is further configured to:
cause the second road-side unit to validate the one or more messages, wherein the second road-side unit is configured to receive the one or more messages based on a location of the first road-side unit, and wherein the validation of the one or more messages is based on the one or more messages matching one or more sanitized operating scenarios defined by a channel busy ratio.

14. The system of claim 12, wherein the first set of remedial actions include:
triggering a global pause in operation of all of the one or more vehicles;
triggering a zonal pause in operation of a subset of the one or more vehicles;
identifying one or more targeted vehicles of the one or more vehicles; or
triangulating, via one or more received signal strength indicator triangulation methods, a location of a third party, wherein the third party is a road-side unit, an on-board unit associated with a vehicle, or a mobile device.

15. The system of claim 12, wherein the infrastructure controller is further configured to:
cause, by the algorithm associated with the infrastructure controller, one or more instructions to be transmitted to one or more road-side units, wherein the one or more road-side units include at least the first road-side unit and the second road-side unit.

16. The system of claim 15, wherein the infrastructure controller is further configured to:
cause the one or more road-side units to randomly change a data rate associated with each of the one or more road-side units based on the one or more instructions;
cause the one or more road-side units to isolate and identify replayed data associated with the one or more messages broadcasted by the first road-side unit based on the one or more instructions; or
cause the one or more road-side units to isolate and identify a location of a third party, wherein the identification of the location of the third party is based on a signal strength of the one or more road-side units, and wherein the third party is a road-side unit, an on-board unit associated with a vehicle, or a mobile device.

17. The system of claim 12, wherein the vehicle controller is further configured to:
determine whether one or more messages broadcasted from the vehicle match a broadcast history associated with the vehicle; and
initiate the one or more remedial actions in response to determining that the one or more messages broadcasted from the vehicle does not match the broadcast history.

18. The system of claim 17, wherein the second set of remedial actions include:
triggering a pause in operation of the vehicle;
transmitting an alert to a central server, a vehicle manufacturing cloud system, one or more operators, or a combination thereof; or
adjusting one or more outgoing data patterns associated with one or more messages broadcasted from the vehicle, wherein the one or more outgoing data patterns include a data rate, a ProSe per packet priority, a modulation and coding scheme, a packet size, or a combination thereof.

19. The system of claim 18, wherein the one or more outgoing data patterns are cross-referenced against the one or more messages broadcasted from the vehicle.

20. The system of claim 12, wherein the vehicle controller is configured to:
identify one or more messages broadcasted by one or more adjacent vehicles, wherein the one or more messages broadcasted by the one or more adjacent vehicles include an alteration of a data rate, a jump in a signal strength, or a combination thereof; and
transmit an alert to a central server based on the identification of the one or more messages broadcasted by the one or more adjacent vehicles.
